(19) United States
(12) Patent Application Publication
(10) Pub. No.: US 2006/0261960 A1
(43) Pub. Date: Nov. 23, 2006

(54) Information recording method and device for battery

(76) Inventors: Kazunori Haraguchi, Osaka (JP); Fumio Daio, Osaka (JP)

Correspondence Address: MCDERMOTT WILL & EMERY LLP, 600 13TH STREET, N.W., WASHINGTON, DC, 20005-3096, US

(21) Appl. No.: 11/435,899

(22) Filed: May 18, 2006

(30) Foreign Application Priority Data
May 18, 2005 (JP) 2005-144804

(51) Int. Cl. G08B 13/14

(52) U.S. Cl. 340/572.8

(57) ABSTRACT

An insulating plastic seat is provided on a sealing plate of a battery, and an IC tag is attached on the seat, the IC tag carrying information required in production, marketing, and use of battery, and information required for management of battery after it has been used.

The present disclosure relates to subject matter contained in priority Japanese Patent Application No. 2005-144804, filed on May 18, 2005, the contents of which is herein expressly incorporated by reference in its entirety.

### BACKGROUND OF THE INVENTION

1. Technical Field of the Invention

The present invention relates to an information recording method and device for battery that enable recording of the information required for production, marketing, and use or the like of battery, and the information required for collection and recycling of battery after it has been used.

2. Description of the Related Art

Most rechargeable batteries are used in plurality in the form of a battery pack or assembly. These batteries used together should preferably have the same characteristics, because there are variations in battery characteristics even though they are the same type of battery. The battery characteristics generally depend on date, month and year of production, contents of production, initial charging/discharging, and charging/discharging at shipping time. Therefore, if each and every battery carries information on its characteristics, it will be more convenient for the production of equipment that uses rechargeable batteries.

Batteries come in all shapes and sizes, including dry batteries or primary batteries and rechargeable batteries. After these batteries have been used, it is important to collect and recycle them to reduce waste and to make effective use of resources. Most primary batteries such as dry batteries are currently treated as domestic waste because of the lack of economical and efficient recycling techniques. Collection and recycling of rechargeable batteries are now obligatory due to the Law for the Promotion of Effective Utilities of Resources. Collectable/recyclable small rechargeable batteries include nickel cadmium batteries, nickel metal hydride batteries, lithium ion batteries, and small sealed lead batteries. Most of these small rechargeable batteries are incorporated in domestic electric appliances, office appliances, communication equipment, and safety equipment in the form of a battery pack or assembly, or as part of a circuit substrate, and are removed as spent batteries at the time of repair, maintenance, or disposal of the equipment. Nickel metal hydride rechargeable batteries that are compatible with dry batteries may be treated after use in the same disposal route as dry batteries, and they need be segregated from discarded dry batteries. Some batteries contain hazardous substances such as cadmium or lead, while other batteries contain rare metals such as cobalt or lithium and precious metals such as gold or platinum, and therefore small rechargeable batteries must all be collected for proper treatment of hazardous substances and for recycling of useful metals. However, segregated collection routes for batteries have not been established yet, and in actuality, various different batteries are all mixed up in the course of collection. In order to segregate these mixed batteries by type, or by materials used or composition, each and every battery is required to carry information necessary for the segregation. For example, while lithium ion rechargeable batteries basically use lithium as active material, there are variations which contain cobalt or manganese.

Also, batteries that use liquid electrolyte containing corrosive materials, or batteries that use ignitable materials, must be transported with due consideration given to safety, and transportation of batteries that fall into the Dangerous Goods List according to the UN recommendations is regulated. Batteries that are widely used and confirmed to be safe in normal handling are exempt from the regulations on the transport if they meet the prescribed requirements, and therefore it is necessary to determine whether the batteries to be transported are subject to the regulations and whether they meet the prescribed requirements. Further, the RoHS Directive, which are EU environmental regulations on electric and electronic equipment, will ban the placing on the EU market of products containing any of six prescribed hazardous substances, and batteries containing cadmium or mercury will be subject to the regulations. Accordingly, batteries require an indication that they do not contain the prescribed hazardous substances.

One known means of recording information on battery on its characteristics or materials used is a bar code or identification pattern on the battery outer package (see, for example, Japanese Patent Publication No. 11-031485). This battery is provided with an ID pattern on the outer package of battery case, which carries information necessary for the use of the battery and on the materials used for the liquid electrolyte, positive and negative electrodes, and battery case, in order to differentiate the battery from many other different types of lithium rechargeable batteries that use different materials and compositions. This recording of information prevents a malfunction or accident caused by wrong use of the battery, as well as enables segregation of the battery containing environmentally harmful substances or recyclable materials after they have been used and discarded.

However, the amount of information that can be recorded by an ID pattern on the outer package of battery is limited, and this approach is not suitable for recording large amount of information such as battery characteristics data. Another problem is that reading and decoding of information become harder as the amount of information increases.

Yet another problem with recording information using a bar code or ID pattern on the outer package of battery case is that when spent batteries are collected for recycling, the information may not be read out accurately because of dirt or blemish on the spent batteries.

Also, quick readout of recorded information from each and every one of a large number of spent batteries is hard to achieve, and when batteries are not correctly oriented, readout of information may not be done at all.

### BRIEF SUMMARY OF THE INVENTION

In view of the above problems of the conventional techniques, an object of the present invention is to provide an information recording method and device for battery, whereby information required for use of battery and information required for segregation of battery after it has been used is recorded in an increased amount, and whereby readout of recorded information is performed in a quick and stable manner.

To achieve the above object, a method for recording information for a battery according to one aspect of the invention includes attaching an IC tag to the battery, the IC tag carrying information required in production, marketing, and use of the battery, and information required for segregation of battery after it has been used.

With the above information recording method, necessary battery-related information is recorded on the IC tag attached to the battery, and the recording capacity will be sufficient for any necessary information. The recorded information is read out as required in a non-contact manner to be effectively used for production, marketing, and use of the battery. Because it is an IC tag that carries information, a situation will not arise where the information cannot be read out because of dirt or blemish on the battery after it has been used. Therefore, spent batteries are segregated based on the information about the battery type or materials used, to collect useful metals and to perform necessary treatment of hazardous substances.

To achieve the above object, a device for recording information for a battery according to a second aspect of the invention includes a metal-compatible IC tag attached to an outer surface of the battery. Since batteries are almost entirely covered by metal, transmission and reception of electromagnetic waves to and from the antenna in a common IC tag will be adversely affected. Therefore a metal-compatible IC tag, which is suitable for metal surface applications, is used, to diminish the metal effect on the IC tag when its information is accessed.

To achieve the above object, a device for recording information for a battery according to a third aspect of the invention includes an IC tag attached on a seat of an insulating material formed on an outer surface of the battery. Since batteries are almost entirely covered by metal, transmission and reception of electromagnetic waves to and from the antenna in a common IC tag will be adversely affected. Therefore the IC tag is attached on the seat of insulating material to diminish the metal effect on the antenna in the IC tag, and to secure a large communication distance between the IC tag and a reader/writer.

The seat in the above structure is formed as an extended portion of a gasket which provides insulation between a sealing plate and a positive or negative terminal provided on the sealing plate, to eliminate the need of providing an additional component for attaching the IC tag. Alternatively, the seat may be formed using an insulating plate arranged upon the sealing plate or at the bottom of the battery case, so that the IC tag is attached to the battery without using an additional component.

To achieve the above object, a device for recording information for a battery according to a fourth aspect of the invention includes an IC tag arranged in an indentation formed in an outer surface of the battery such that its antenna part is positioned almost flush with the outer surface of the battery. Even if the IC tag is attached to the metal surface of battery, if the antenna is positioned almost flush with the outer surface, the metal effect on the antenna is diminished.

A suitable means of arranging the IC tag in the indentation formed in the outer surface of battery is to bond the IC tag to the inner surface of an outer label that covers the outer surface of the battery opposite the indentation. The inner face of the outer label is flush with the outer surface of the battery, and therefore, by bonding the IC tag to the inner surface of the outer label opposite the indentation, the IC tag is separated sufficiently from the metal surface, and the IC tag is formed by forming an antenna on the outer label by metal deposition or the like and connecting the antenna to an IC chip.

To achieve the above object, a device for recording information for a battery according to a fifth aspect of the invention includes an IC tag attached to an insulating plate arranged upon a sealing plate for closing an open end of a battery case that accommodates elements for electromotive force, the insulating plate being separated from the sealing plate a predetermined distance. With this structure, the IC tag is attached to the insulating plate which is positioned away from the metal sealing plate, and therefore, even though the IC tag is attached to the metal-covered battery, the metal effect is diminished.

To achieve the above object, a device for recording information for a battery according to a sixth aspect of the invention includes an IC tag comprising a battery case that serves as a first antenna, a metal film on an insulating plastic outer label covering the battery case to serve as a second antenna, and an IC chip connected to the first and second antennas. Battery generally includes a metal battery case for accommodating elements for electromotive force, the battery case being closed and covered by an insulating plastic outer label. The metal film on this outer label serving as the second antenna enables formation of an IC tag that uses electrostatic coupling, with the outer label serving as an insulating layer and the battery case as the first antenna. Thus, even though the tag is on the metal-covered battery, information in the tag is accessed by a reader/writer by electrostatic coupling.

To achieve the above object, a device for recording information for a battery according to a seventh aspect of the invention includes an IC tag attached to a hollow part in between parallel arranged batteries in a battery pack, wherein a plurality of cylindrical batteries are arranged in parallel and united, at least either end of the batteries in the height direction being covered by an insulating material apart from positive and negative terminals that are exposed. In a battery pack formed as one battery by connecting a plurality of cylindrical batteries in series for use in high voltage equipment, large-volume hollow parts are formed between the parallel arranged cylindrical batteries, and therefore by attaching the IC tag in the hollow part via insulating material, the IC tag is attached with reduced metal effect.

In any of the above designs, an IC chip constituting the IC tag attached on the battery may be configured to draw operating power therefor from the battery. If the IC tag draws its operating power from the battery, it compensates for a decrease in the communication distance between a reader/writer and the IC tag attached on the metal-covered battery by the increased drive power. A suitable structure for supplying power from the battery to the IC chip is to provide a power supply circuit that turns on when a radio wave signal is input from a reader/writer, to save wasteful consumption of battery power.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a perspective view illustrating the attachment structure of an IC tag on a battery according to a first embodiment of the present invention;

FIG. 2A is a cross-sectional view illustrating one example in which the above structure is applied to a cylindrical battery, and FIG. 2B is a cross-sectional view illustrating the cylindrical battery with the IC tag attached to the insulating plate at the top and the bottom;

FIG. 3A is a partial cross-sectional view illustrating the attachment structure of an IC tag on a battery according to a second embodiment of the present invention, and FIG. 3B is a partial cross-sectional view illustrating an IC tag attachment structure on an outer label;

FIG. 4 is a perspective view illustrating the attachment structure of an IC tag on a battery according to a third embodiment of the present invention;

FIG. 5 is a cross-sectional view illustrating the attachment structure of an IC tag on a battery according to a fourth embodiment of the present invention;

FIG. 6 is a block diagram illustrating the structure of an IC tag according to a fifth embodiment of the present invention; and

FIG. 7A and FIG. 7B are perspective views illustrating the attachment structure of an IC tag on a battery according to a sixth embodiment of the present invention.

### DESCRIPTION OF THE PREFERRED EMBODIMENTS

Preferred embodiments of the present invention will be hereinafter described with reference to the accompanying drawings. This embodiment is a method of recording information for a battery, wherein an IC tag is attached to each and every battery, the IC tag carrying information required in production, marketing, and use of the battery, and information required for collection and recycling of spent batteries, so that the information is read out from the IC tag at various points of battery life transition and used for the production, marketing, or use of the battery, or for the segregation of the battery after it has been used. The following description is given for illustrating examples of embodiment of the invention and is not intended to limit the technical scope of the invention.

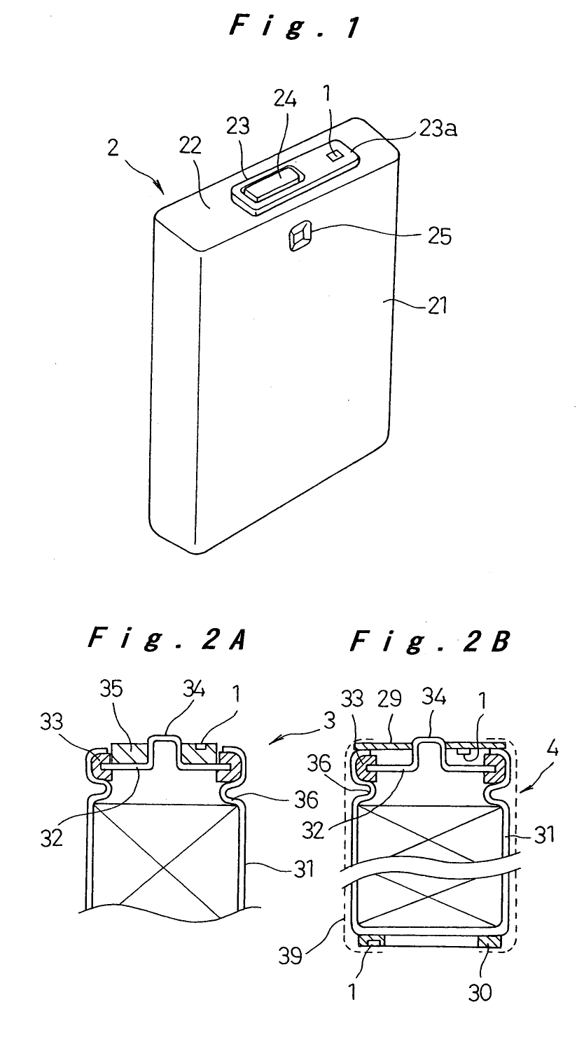

FIG. 1, FIG. 2A, and FIG. 2B illustrate the structure of an information recording device for a battery according to a first embodiment, wherein an IC tag is attached on an insulating plastic seat provided upon the sealing plate of battery, to diminish the metal effect caused by directly attaching the IC tag on metal.

FIG. 1 illustrates a prismatic lithium ion rechargeable battery 2 with an IC tag 1 attached thereon. Elements for electromotive force are accommodated in a square tubular battery case 21 with a bottom, and the IC tag 1 is attached on a seat 23a upon a sealing plate 22 for closing the open end of the case. The sealing plate 22 is laser-welded to the battery case 21 in its periphery, and provided with a negative (or positive) terminal 24 in the center, which is insulated from the sealing plate 22 by a plastic gasket 23. An extended portion of the gasket 23 is used as the seat 23a.

FIG. 2A illustrates a cross section of a cylindrical lithium ion rechargeable battery 3 with an IC tag 1 attached thereon. Elements for electromotive force are accommodated in a cylindrical battery case 31 with a bottom, and the IC tag 1 is attached on a plastic seat 35 upon a sealing plate 32, which closes the open end of the battery case 31 via a gasket 33. A positive (or negative) terminal 34 protrudes from the center of the sealing plate 32, and the seat 35 has a thickness so that its upper face is lower than the top of the positive terminal 34.

Alternatively, with cylindrical lithium batteries that have an upper insulating plate 29 upon the sealing plate 32 and a lower insulating plate 30 at the bottom of the battery case as shown in FIG. 2B, the IC tag 1 may be attached to the inside of the upper insulating plate 29, so as to secure a distance from the sealing plate 32 which is metal, or, the IC tag 1 may be attached to the lower insulating plate 30, in which case the lower insulating plate 30 should be made as thick as possible to secure a distance from a metal surface, whereby the IC tag 1 is attached to the battery with reduced metal effect. The upper insulating plate 29 and the lower insulating plate 30 are secured using a heat-shrinkable, tacky outer label 4.

Most batteries are almost entirely covered by metal as with the above examples, and if the IC tag 1 is directly attached on the metal sealing plate 22 or 32, it is hard to secure a sufficient communication distance because of the metal effect on the radio waves from a reader/writer. With a passive tag, in particular, which draws operating power of its IC chip from electromotive force induced by an antenna inside the tag when radio waves are transmitted from the reader/writer, the electromotive force must be larger than the operating power of the IC chip. By providing a plastic seat 23a or 35 upon the metal sealing plate 22 or 32 and attaching the IC tag 1 on the seat as in the above-described designs, the effects of metal on-radio waves are mitigated.

The thickness of the seat 23a or 35 cannot be set freely because of limitations on the outer dimensions of battery. In the above examples, the thickness is set such that the seat does not protrude beyond the top of the negative terminal 24 or the positive terminal 34 formed on the sealing plate 22 or 32. When the battery design does not allow the seat 23a or 35 to have a sufficient thickness, then it is preferable that a metal-compatible IC tag should be used.

Known metal-compatible IC tags 1 include an amorphous sheet on the surface that makes contact with metal, or an amorphous magnetic sheet upon the antenna part of the IC tag, and these tags are suitably used for batteries that are entirely covered with metal.

The above-described IC tag 1 is attached upon the sealing plate of a prismatic or cylindrical battery. However, as shown in FIG. 2A and FIG. 2B, in cylindrical batteries which use the sealing plate 32 for closing the open end of the battery case 31, an inward indentation 36 is formed around the circumference at the open end of the battery case 31 to provide a step for holding a gasket 33, which is for sealing the case together with the sealing plate 32. The IC tag 1 may be attached in this indentation 36. With a prismatic battery, an indentation 25 may be formed as shown in FIG. 1 in the upper part of the battery case 21 corresponding to the space between the bottom of the sealing plate 22 and elements for electromotive force, and the IC tag 1 may be attached in this indentation 25.

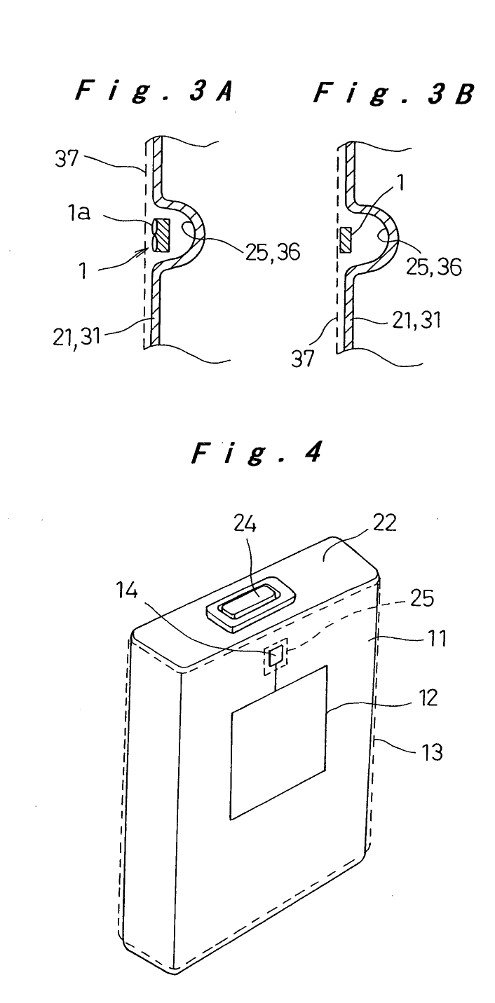

When the IC tag 1 is attached in such indentation 25 or 36, the magnetic field attenuation, which increases with the depth of the indentation 25 or 36 in the metal battery case 21 or 31, will impede communication with the antenna in the IC tag 1. However, since the magnetic field attenuation is lower in the metal surface direction, if the IC tag 1 is attached at a position such that its antenna coil 1a is slightly lower than the position which would be flash with the outer surface of the battery case 21 or 31 as in the second embodiment shown in FIG. 3A, then a sufficiently large communication distance for the IC tag is secured because of electromagnetic induction. As the circumferential surface of the battery case 21 or 31 is usually covered by an outer label 37, the IC tag attached in the indentation 25 or 36 is covered and protected by the outer label 37.

If the IC tag 1 is bonded to the inner surface of the outer label 37 opposite the indentation 25 or 36 as shown in FIG. 3B, then the IC tag 1 will be attached suitably because the inner surface of the outer label 37 is flash with the outer surface of the battery case 21 or 31.

As the battery is almost entirely covered by metal as described above, it is not a desirable condition for the communication between the IC tag 1 on the battery and the reader/writer. However, communication with the IC tag 1 is achieved using electrostatic coupling, by making use of this metal-covered structure.

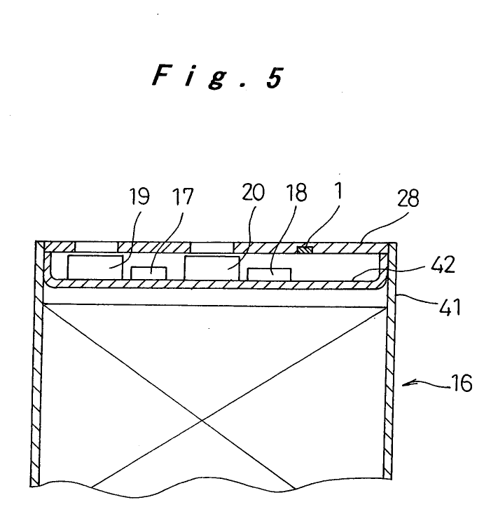

FIG. 4 illustrates the IC tag attachment structure according to a third embodiment, wherein the battery case 11 of a prismatic battery serves as a first antenna, and a second antenna 12 is formed by aluminum deposition on the outer label 13 covering the battery case 11, the plastic layer of the outer label 13 providing insulation between the first antenna or battery case 11 and the second antenna 12. The battery case 11 and the second antenna 12 are connected to the IC chip 14, which is mounted in the indentation 25, as with the above-described IC tag attachment structure. The outer label 13 is a plastic film having at least two layers. The second antenna 12 of a predetermined shape and size is formed by deposition on the inner face of the front side film, which is covered by the back side film, and the back side film serves as the insulation layer between the antenna 12 and the battery case 11.

When the second antenna 12 is brought near the positively charged antenna of the reader/writer, negative charges are produced on the second antenna 12. When the battery case 11 is grounded, a potential difference is created between the first antenna or battery case 11 and the second antenna 12 and current flows, whereby the IC chip 14 is operated, enabling communication between the reader/writer and the IC tag 1. The battery case 11 does not need to be at the actual ground potential, but may only be touched by part of a human body to achieve the same effects.

As one alternative, the first and second antennas may both be formed on the outer label 13, with one antenna being grounded, to achieve communication using electrostatic coupling.

FIG. 5 illustrates the IC tag attachment structure according to a fourth embodiment, wherein the battery has a design that reduces the metal effect on the IC tag. The battery 16 is structured as a lithium rechargeable battery and provided with a PTC element 17 and a temperature fuse 18 as part of the battery to protect the battery from external short-circuiting and abnormal temperature rise. To attach the PTC element 17 and the temperature fuse 18 on the battery, the sealing plate 42 for closing the open end of the battery case 41 is inwardly concaved at the open end of battery case 41. The PTC element 17 and the temperature fuse 18 are set inside the hollow space formed by this sealing plate 42, and the space above the sealing plate 42 is covered by an insulating plate 28, with the positive terminal 19 and the negative terminal 20 being exposed to the outside.

The IC tag 1 is attached to the inner side of the insulating plate 28 as illustrated so that it is well apart from the sealing plate 42 and the battery case 41 which are made of metal, to diminish the metal effect.

If the IC tag 1 attached to the battery is a passive tag, the electromotive force induced by the antenna is too small to enable communication with the reader/writer because of the metal-covered design of battery, and the IC tag 1 requires an attachment structure suitable for metal surface applications as described above. One effective alternative approach is to design the battery such that power is supplied to the IC tag 1, i.e., to make the tag active. However, if the IC tag 1 is constantly connected to the battery, the battery power is, although slightly, consumed, and therefore a desirable structure would include a semiconductor switch to keep shut the power supply rout from the battery until the IC tag is accessed by a reader/writer.

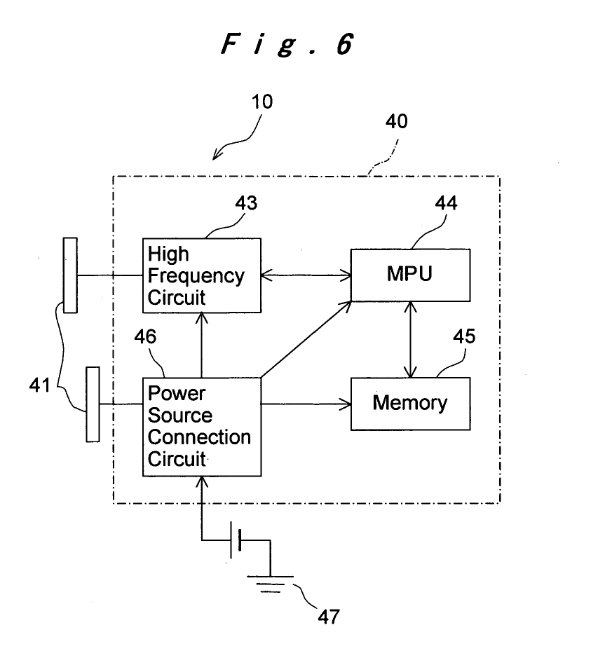

FIG. 6 illustrates the structure of an IC tag 10 which draws its operating power from the battery. Instead of a power generating circuit provided in a passive tag to generate operating power for the IC chip 40 in response to radio waves transmitted from a reader/writer, the IC tag has a power source connection circuit 46 for turning on the circuit that controls power supply from the battery 47 when the tag receives radio waves from the reader/writer.

In a state where the IC tag 10 is not accessed by the reader/writer, the IC chip 40 does not operate since the power source connection circuit 46 is turned off so that it is not connected to the battery 47. Therefore, battery power consumption is very low, which is caused by dark current. When the IC tag 10 is accessed by the reader/writer, the power source connection circuit 46 is turned on by the electromotive force induced by the antenna 41 so that operating power is supplied from the battery 47 to the IC chip 40 and the IC tag 10 transmits information in response to a request from the reader/writer.

With the above structure, as the IC tag 10 draws operating power from the battery 47 on which it is attached, it outputs radio waves sufficiently to compensate for attenuation of radio frequency signals caused by attaching the IC tag 10 on the metal-covered battery. On the other hand, since the battery 47 is consumed by dark current from the battery 47 to IC tag 10, this structure is not suitable for batteries that are used on their own, but is suitable for large-capacity batteries or batteries that are mounted in equipment.

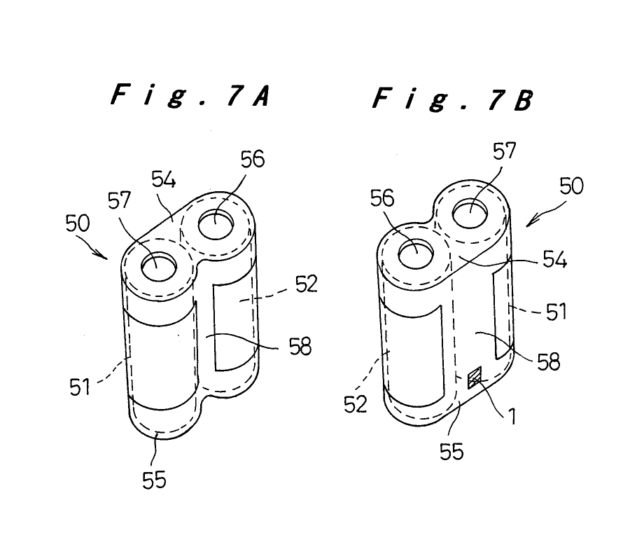

Electromotive force of batteries is generally small, and therefore battery packs which are made by uniting a plurality of series-connected batteries to have a required voltage as one battery are widely used for equipment that requires a relatively large battery voltage, particularly for cameras and the like. The most commonly used battery pack is a 6V output voltage battery pack that is made by two parallel arranged, electrically series-connected cylindrical lithium primary batteries. This battery pack is, as shown in FIG. 7A, made by uniting two cylindrical batteries 51 and 52, which are arranged in parallel and electrically connected in series, at least both ends of the batteries being covered by plastic covers 54 and 55, these covers being connected by a coupling part 58. A hollow space 53 is formed on one side between the two cylindrical batteries 51 and 52, so that the hollow space 53 will engage with a protrusion provided in a battery accommodating space of equipment such as a camera or the like, to prevent the positive terminal 56 and negative terminal 57 from being reversely connected.

With such a battery pack 50, since there is a space enclosed by the plastic covers 54 and 55 between the two cylindrical batteries 51 and 52, the IC tag 1 is attached to the plastic covers 54 and 55 as shown in FIG. 7B, so that it is well apart from the metal part of the cylindrical batteries 51 and 52, and thus an IC tag attachment structure that diminishes the metal effect is achieved.

As described above, according to the present invention, necessary information is recorded on the IC tag attached to battery so that it is read out as required in various steps of production, marketing, and use of battery, to be effectively used for battery management or classification. Also, spent batteries are segregated by type or materials used based on the information recorded on the IC tag for proper collection of useful metals or treatment of hazardous substances. Also, even though the IC tag is attached to batteries that are almost entirely covered by metal, the information is accessed by a reader/writer, and thus information required for production, marketing, use, and segregation after use of the battery is recorded.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A method for recording information for a battery, comprising attaching an IC tag to the battery, the IC tag carrying information required in production, marketing, and use of the battery, and information required for segregation of battery after it has been used.

2. A device for recording information for a battery, comprising a metal-compatible IC tag attached to an outer surface of the battery.

3. The device for recording information for a battery according to claim 2, wherein an IC chip constituting the IC tag attached on the battery is configured to draw operating power therefor from the battery.

4. The device for recording information for a battery according to claim 3, wherein supplying power from the battery to the IC chip is achieved by providing a power supply circuit that turns on when a radio wave signal is input from a reader/writer.

5. A device for recording information for a battery, comprising an IC tag attached on a seat of an insulating material formed on an outer surface of the battery.

6. The device for recording information for a battery according to claim 5, wherein the seat is formed as an extended portion of a gasket which provides insulation between a sealing plate and a positive or negative terminal provided on the sealing plate.

7. The device for recording information for a battery according to claim 5, wherein the seat is an insulating plate arranged upon a sealing plate or at a bottom of a battery case.

8. The device for recording information for a battery according to claim 5, wherein an IC chip constituting the IC tag attached on the battery is configured to draw operating power therefor from the battery.

9. The device for recording information for a battery according to claim 8, wherein supplying power from the battery to the IC chip is achieved by providing a power supply circuit that turns on when a radio wave signal is input from a reader/writer.

10. A device for recording information for a battery, comprising an IC tag arranged in an indentation formed in an outer surface of the battery such that an antenna part of the IC tag is positioned almost flush with the outer surface of the battery.

11. The device for recording information for a battery according to claim 10, wherein the IC tag is bonded to an inner surface of an outer label that covers the outer surface of the battery opposite the indentation.

12. The device for recording information for a battery according to claim 10, wherein an IC chip constituting the IC tag attached on the battery is configured to draw operating power therefor from the battery.

13. The device for recording information for a battery according to claim 12, wherein supplying power from the battery to the IC chip is achieved by providing a power supply circuit that turns on when a radio wave signal is input from a reader/writer.

14. A device for recording information for a battery, comprising an IC tag attached to an insulating plate arranged upon a sealing plate for closing an open end of a battery case that accommodates elements for electromotive force, the insulating plate being separated from the sealing plate a predetermined distance.

15. The device for recording information for a battery according to claim 14, wherein an IC chip constituting the IC tag attached on the battery is configured to draw operating power therefor from the battery.

16. The device for recording information for a battery according to claim 15, wherein supplying power from the battery to the IC chip is achieved by providing a power supply circuit that turns on when a radio wave signal is input from a reader/writer.

17. A device for recording information for a battery, comprising an IC tag comprising a battery case that serves as a first antenna, a metal film on an insulating plastic outer label covering the battery case, the metal film serving as a second antenna, and an IC chip connected to the first antenna and the second antenna.

18. The device for recording information for a battery according to claim 17, wherein an IC chip constituting the IC tag attached on the battery is configured to draw operating power therefor from the battery.

19. The device for recording information for a battery according to claim 18, wherein supplying power from the battery to the IC chip is achieved by providing a power supply circuit that turns on when a radio wave signal is input from a reader/writer.

20. A device for recording information for a battery, comprising an IC tag attached to a hollow part in between parallel arranged batteries in a battery pack, wherein a plurality of cylindrical batteries are arranged in parallel and united, at least either end of the batteries in a height direction being covered by an insulating material apart from positive and negative terminals that are exposed.

21. The device for recording information for a battery according to claim 20, wherein an IC chip constituting the IC tag attached on the battery is configured to draw operating power therefor from the battery.

22. The device for recording information for a battery according to claim 21, wherein supplying power from the battery to the IC chip is achieved by providing a power supply circuit that turns on when a radio wave signal is input from a reader/writer.
